(19) United States
(12) Patent Application Publication
(10) Pub. No.: US 2011/0159930 A1
(43) Pub. Date: Jun. 30, 2011

(54) Compact Mobile Phone Power Supplement Device

(76) Inventors: Peter Garrett, Aptos, CA (US); Paul Regen, Felton, CA (US)

(21) Appl. No.: 12/979,944

(22) Filed: Dec. 28, 2010

Related U.S. Application Data
(60) Provisional application No. 61/290,446, filed on Dec. 28, 2009.

(51) Int. Cl. H04W 88/02

(52) U.S. Cl. 455/573

(57) ABSTRACT

A power supplement device for a mobile telephone has a casing having a width, a height, a length, a first end and a second end each defined by the width and height, a top side and a backside each defined by the width and length, and a left edge and a right edge each defined by the length and height, the width and length being substantially the same as a mobile telephone to which the supplemental power device is intended to couple, a male connector implemented in the area of the first end, extending in the length direction, and compatible with a female connector of the mobile telephone to which power charging devices are typically connected to the mobile telephone, a USB male connector implemented in an area of the second end or an area of one of the two edges, a back-up battery enclosed in the casing and coupled to the male connector implemented in the area of the first end, providing supplemental power to the mobile telephone, the backup battery also connected to charging circuitry enabling charging of the battery from an external AC power source, and a flip-out AC outlet plug implemented on either the front or the back and coupled to the charging circuitry, enabling the power supplement device to be coupled to AC power to charge the backup battery and the mobile telephone.

### CROSS-REFERENCE TO RELATED APPLICATIONS

The present application claims priority to U.S. provisional patent application Ser. No. 61/290,446, filed on Dec. 28, 2009. The entire disclosure is included herein in its entirety at least by reference.

### BACKGROUND OF THE INVENTION

1. Field of the Invention

The present invention relates generally, to the field of mobile phone charging devices. But more particularly, to a device that may allow for a plurality of charging voltages and industry standard plug-in interfaces, commonly utilized by these types of consumer electronics devices today.

2. Description of Related Art

Mobile phone charging devices have become a necessity to the mobile phone consumer. The charging device allows the user to recharge their mobile phone battery when the stored energy has been depleted, or expended entirely. While there are several methods and devices by which the industry has devised methods to accomplish this, they are not always compatible with the available power source, or they are often cumbersome to the user.

Presently, a mobile phone user may have to carry an plug-in AC adapter or a docking cradle to charge their phone. This present method, denies a user the liberty of being tether free, or of having their hands free to operate their phone and utilize the full potential of its mobility. Furthermore, the various charging devices for the present methods of recharging are prone to being lost or misplaced. Also, the users may find themselves untangling a mess of wires from multiple charging devices, before they are able to use the charger for their particular mobile phone.

Therefore, the inventors of the present disclosure have clearly identified a need for a new mobile phone power supplement device, which may allow a user to always have a compact mobile phone charger present and structured for ease of use, when it is most needed. It has also occurred to the inventors that such a mobile phone charger may be attached to a user's mobile phone, at all times. The mobile phone power supplemental device may have a slim form factor, in order to be an integral part of, or a removable component of the phone, for example, without adding significant bulk to the mobile phone itself. It has also occurred to the inventors, that such a mobile phone charging device may allow the user to charge the mobile phone, by way of an AC adapter, USB form connection or other common power connector type, which may allow a user to scavenge power from a USB or similarly equipped device, when an AC power source is not available.

### BRIEF SUMMARY OF THE INVENTION

In an embodiment of the invention a power supplement device for a mobile telephone is provided, which has a casing having a width, a height, a length, a first end and a second end each defined by the width and height, a top side and a backside each defined by the width and length, and a left edge and a right edge each defined by the length and height, the width and length being substantially the same as a mobile telephone to which the supplemental power device is intended to couple, a male connector implemented in the area of the first end, extending in the length direction, and compatible with a female connector of the mobile telephone to which power charging devices are typically connected to the mobile telephone, a USB male connector implemented in an area of the second end or an area of one of the two edges, a back-up battery enclosed in the casing and coupled to the male connector implemented in the area of the first end, providing supplemental power to the mobile telephone, the backup battery also connected to charging circuitry enabling charging of the battery from an external AC power source, and a flip-out AC outlet plug implemented on either the front or the back and coupled to the charging circuitry, enabling the power supplement device to be coupled to AC power to charge the backup battery and the mobile telephone.

### BRIEF DESCRIPTION OF THE SEVERAL VIEWS OF THE DRAWINGS

FIG. 1 is a plan view of a compact mobile phone charging device interfaced to a mobile phone, according to one embodiment of the present invention.

FIG. 2 is an oblique right side perspective view of the compact mobile phone charging device of FIG. 1, according to one embodiment of the present invention.

FIG. 3 is an oblique left side perspective view of a compact mobile phone charging device of FIG. 1, according to one embodiment of the present invention.

FIG. 4 is an oblique underside perspective view of the compact mobile phone charging device of FIG. 1, according to one embodiment of the present invention.

FIG. 5 is an isometric view of the underside of the compact mobile phone charging device of FIG. 4, according to one embodiment of the present invention.

FIG. 6 is an oblique underside view of the compact mobile phone charging device of FIG. 1, according to one embodiment of the present invention.

FIG. 7 is an oblique view of the topside of a mobile phone, with the charging and interface elements of the previous embodiments of FIG. 1 integrated into a single device, according to one embodiment of the present invention.

FIG. 8 is oblique view of the underside of the mobile phone of FIG. 7, according to one embodiment of the present invention.

### DETAILED DESCRIPTION OF THE INVENTION

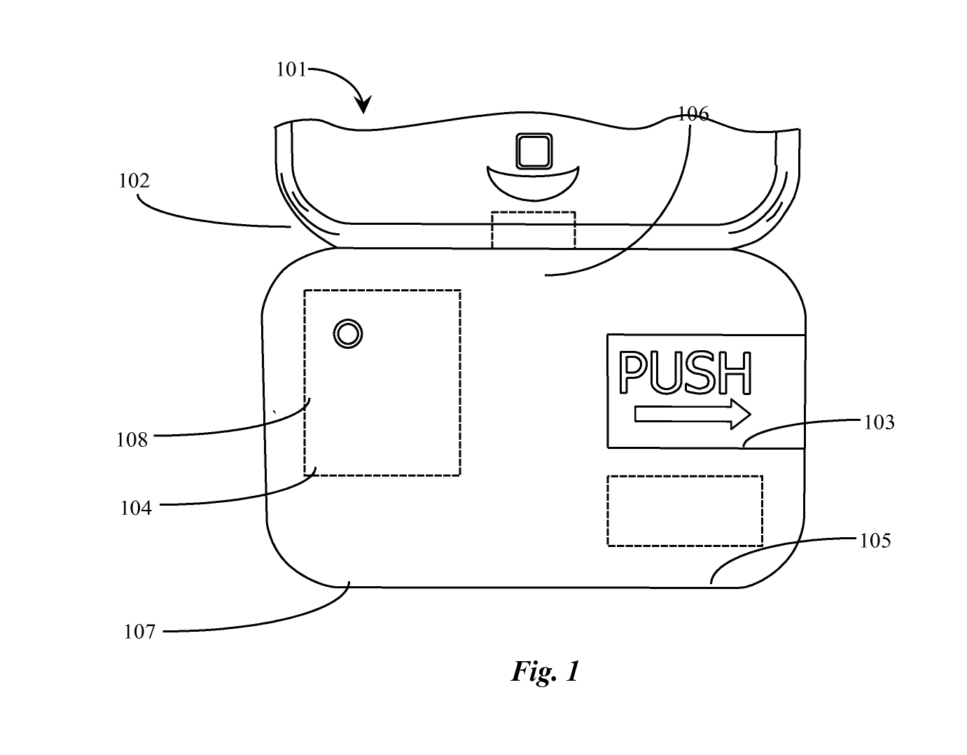

FIG. 1 is a plan view for a compact mobile phone charging device 101, also termed herein a power supplement device, according to one embodiment of the present invention. The compact mobile phone charging device may comprise a slim and compact design which interfaces to a user's mobile phone 102, by way of the mobile phone and the compact mobile phone charging device's interface port element 106. The charging device may remain attached to the user's mobile phone at all times during the phone's use, thus affording a user the means of always having a charger with their phone, without the need to carry any extra devices. The charging device may also be detached, allowing a user to attach their mobile phone to other powering or communication devices, which may utilize the mobile phones integrated port.

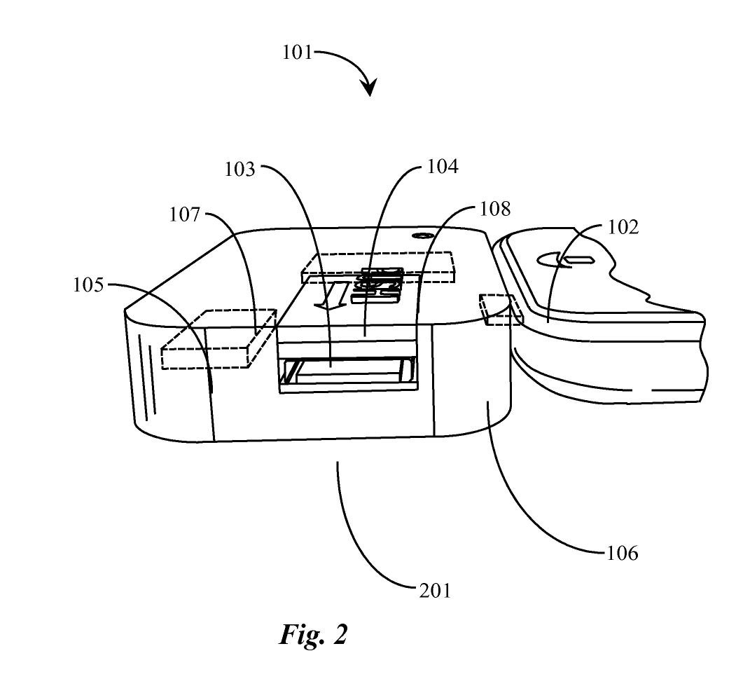

The compact mobile phone charging device of FIG. 1 may also comprise an LED indicator element 108, for visibly displaying the device's charging status. The charging device may comprise a retractable USB slide element 103. A user may push down and slide this area laterally, to expose a retractable USB head 201 (as illustrated in FIG. 2). The retractable USB head may be used to plug the compact mobile phone charging device into an available USB port as a secondary or alternate means for charging the mobile phone, according to one embodiment of the present invention.

The compact mobile phone charging device may comprise an internal backup battery element 104. The internal backup battery may provide backup power to a user's mobile phone, should the user's mobile phone go dead and a charging source is not readily available to recharge the mobile phone. For instance, having a backup source of power may allow a user to continue to use their mobile phone for a short period, until they are able to recharge it, at a later time.

The compact mobile phone charging device may also comprise an internal FM frequency transmitter 105, according to one embodiment of the present invention. A user may transmit music and/or audio from their mobile phone to an FM equipped radio (such as a car stereo, a home stereo or a portable FM radio) over an FM frequency without having to utilize a separate docking cradle.

The above mentioned elements of the compact mobile phone charging device 101 may all be packaged within a stylistic and appropriately compact device housing 107. The form and manufacture, which proper environmental and electronics disciplines may indeed dictate, will certainly drive the shape and materials to which are common to these types of devices today, and are well known to an artisan of the consumer electronics industry.

FIG. 2 is an oblique right side perspective view. It illustrates the compact mobile phone charging device, according to one embodiment of the present invention and further depicts the previously mentioned retractable USB head 201, which the user may deploy by pushing down and sliding the retractable USB slider 103 laterally, exposing the USB head for connection to an available USB port. For example, a user may plug the retractable USB head into a USB Port connected to a power source (such as with a computer, or automobile cigarette lighter charging adapter) to charge the mobile phone. In another example, a user may plug the retractable USB head into a portable device not connected to a power source (such as a laptop, MP3 Player or GPS unit) and scavenge power from that device, to charge their mobile phone.

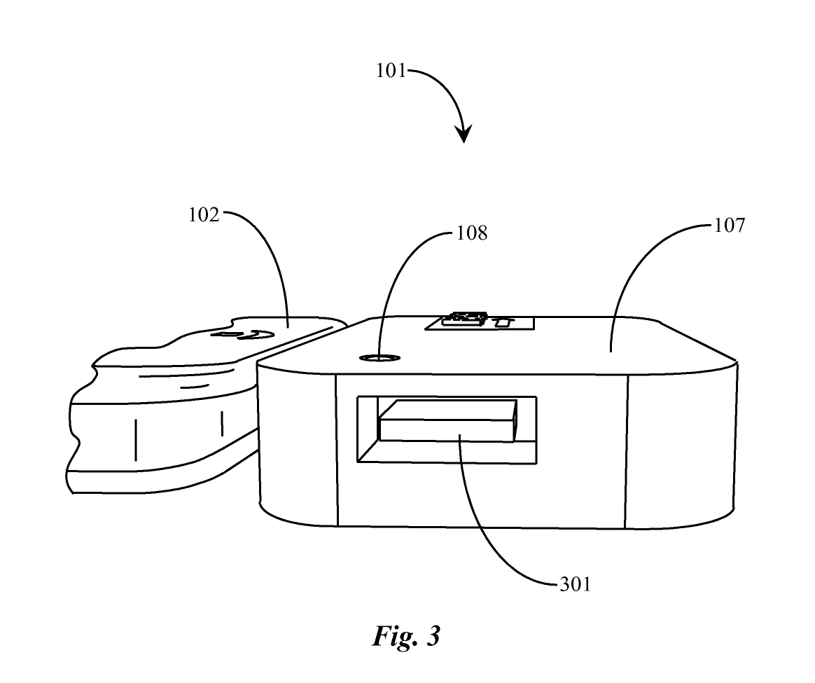

FIG. 3 is an oblique left side perspective view which illustrates the compact mobile phone charging device of FIG. 1. In this illustration, compact mobile phone charging device may also comprise a USB pass thru port 301. The pass thru port may be utilized for example, when the compact mobile phone charging device is plugged into a user's computer or laptop. The USB pass thru may allow a user to continue to operate the USB port, which would otherwise be blocked.

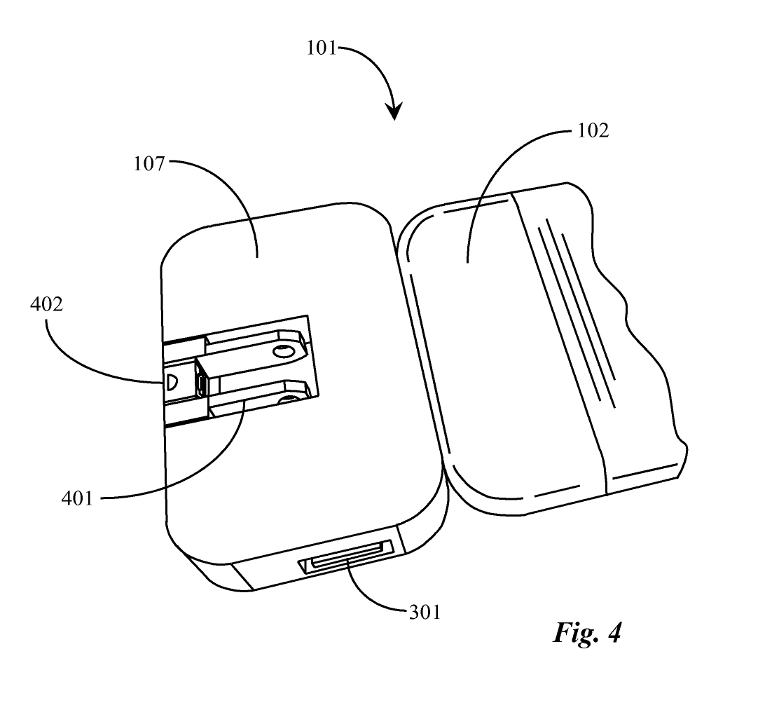

FIG. 4 is an oblique underside perspective view of the compact mobile phone charging device of FIG. 1, and illustrates a flip-out AC outlet plug element 401 in its retracted position, according to one embodiment of the present invention. A user could deploy the flip-out outlet plug, which could lock at ninety (90) degrees, and plug the charging device, with the mobile phone still attached, into a standard AC outlet. It should be noted that, this is the preferred means by which the compact mobile phone charging device may be used, to charge a mobile phone. By incorporating a rotational factor into the AC plug element, the orientation possibilities of the device, while being plugged in, greatly reduces the propensity to block the remaining plug-in station, for that particular AC outlet.

The compact mobile phone charging device 101 may also comprise a slide-out mini USB head element 402. A smaller USB head, such as an industry standard mini USB or micro USB, may be incorporated into the flip-out AC outlet plug of the device, according to one embodiment of the present invention. In other embodiments, this mini or micro USB head may flip out and lock into the 90 or 180 degree positions, allowing more flexibility for orientation purposes. The slide-out mini or micro USB head, acting independently of the flip-out AC outlet plug, serves as yet another means by which to recharge a mobile phone connected to the compact mobile phone charging device, when a standard AC outlet or a standard USB port is not available. It should be noted that a user may also plug the slide-out mini or micro USB head into a portable device, not connected to a power source, but having an available stored energy in its battery, such as a laptop, MP3 Player or GPS unit, for example. Thus, scavenging energy from that device to re-charge their mobile phone becomes possible.

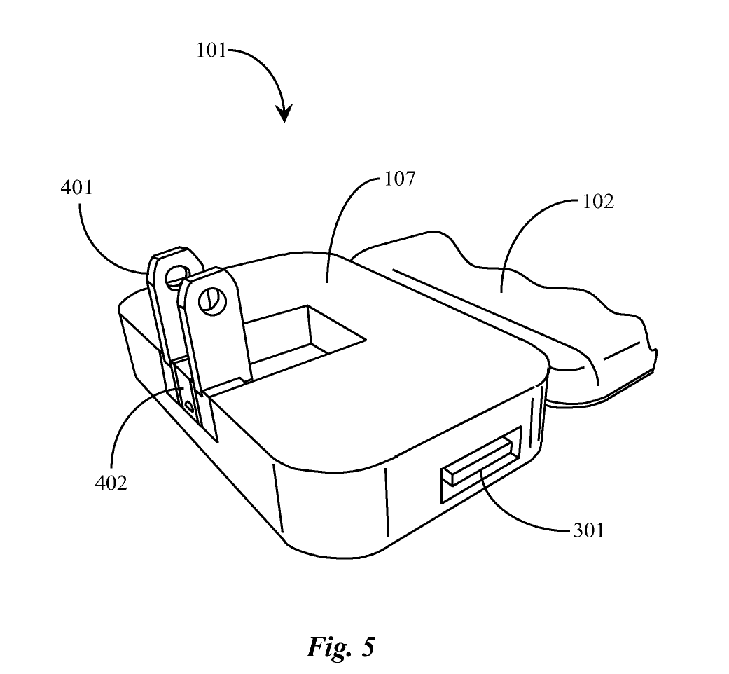

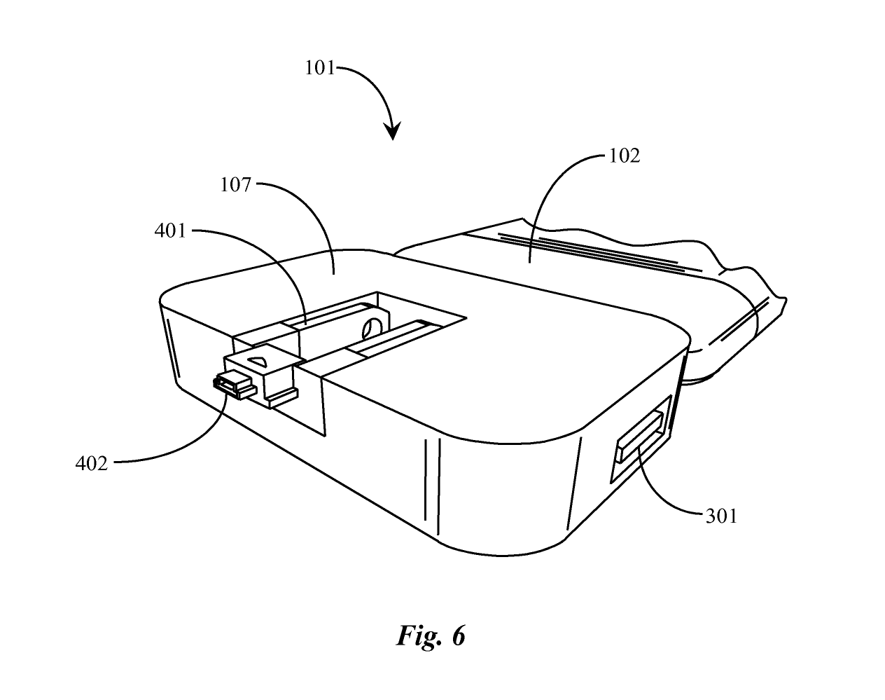

FIG. 5 and in conjunction with FIG. 6, being oblique underside perspective views of the compact mobile phone charging device of FIG. 1 are used to further illustrate the positions of the flip-out AC outlet plug element 401 and the slide-out mini USB head element 402. These elements are depicted in their retracted and deployed positions respectively, according to one embodiment of the present invention.

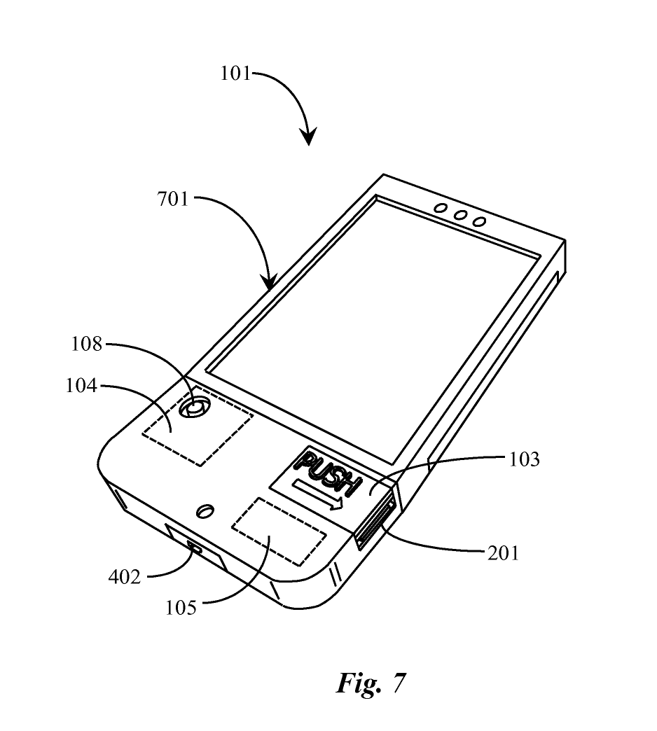

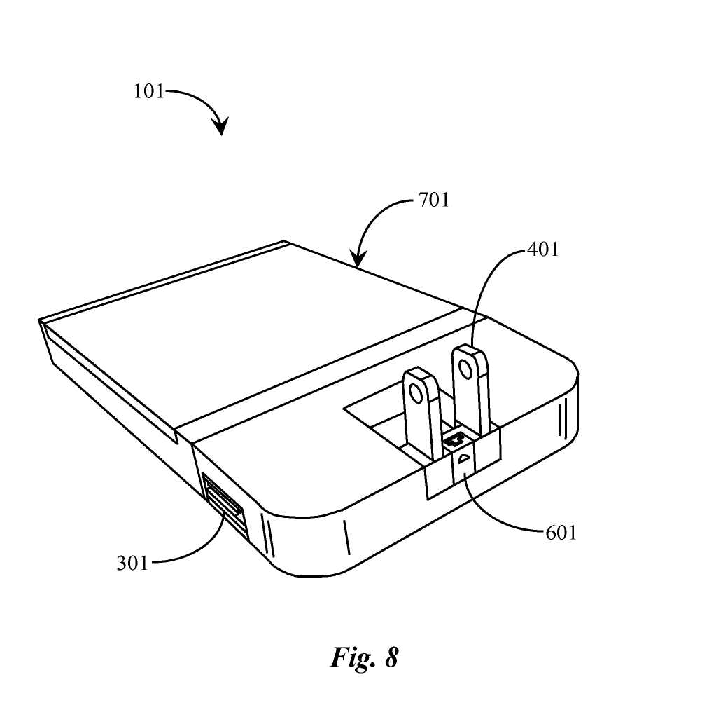

FIG. 7 and in conjunction with FIG. 8 are oblique isometric views of the top and undersides of the compact mobile phone charging device depicted in previous illustrations, wherein all of the elements of the previously described embodiment of the compact mobile phone charging device of FIG. 1, may be integrated into a single mobile phone device 701. Thereby, creates a new type of mobile phone by which the various charging port elements are integrated into single device. The integration of these elements into one device, may afford the user to eliminate the need for a detachable compact mobile phone charging device 101, a standard plug-in style mobile phone charger, an adapter or docking cradle to accomplish the necessary re-charging of the battery or attach the device to various electronics components for communications, such as the porting or syncing of data.

It will be apparent to a skilled artisan that the embodiments described above are exemplary of inventions that may have greater scope than any of the singular descriptions. There may be many alterations made in these examples without departing from the spirit and scope of the invention. For example, the size, shape and configuration may vary widely. The connection methods of the compact mobile phone charging device, portability, charging and re-charging of the device, as well as the orientation and configuration of the various mobile phone interfaces, may be accommodated in numerous ways, known to any consumer electronics artisan. These and many other features may change in different embodiments.

1. A power supplement device for a mobile telephone, comprising:
a casing having a width, a height, a length, a first end and a second end each defined by the width and height, a top side and a backside each defined by the width and length, and a left edge and a right edge each defined by the length and height, the width and length being substantially the same as a mobile telephone to which the supplemental power device is intended to couple;
a male connector implemented in the area of the first end, extending in the length direction, and compatible with a female connector of the mobile telephone to which power charging devices are typically connected to the mobile telephone;
a USB male connector implemented in an area of the second end or an area of one of the two edges;
a back-up battery enclosed in the casing and coupled to the male connector implemented in the area of the first end, providing supplemental power to the mobile telephone, the backup battery also connected to charging circuitry enabling charging of the battery from an external AC power source; and
a flip-out AC outlet plug implemented on either the front or the back and coupled to the charging circuitry, enabling the power supplement device to be coupled to AC power to charge the backup battery and the mobile telephone.
